(19) United States
(12) Patent Application Publication
(10) Pub. No.: US 2024/0034217 A1
(43) Pub. Date: Feb. 1, 2024

(54) Conveyor lamella, and conveyor floor with such a conveyor lamella

(71) Applicant: Cargo Mac B.V., Coevorden (NL)

(72) Inventors: Frans Arian Heino DE RAAD, COEVORDEN (NL); Nicolaas Marc MATER, COEVORDEN (NL)

(21) Appl. No.: 18/268,548

(22) PCT Filed: Dec. 15, 2021
(86) PCT No.: PCT/NL2021/050766

§ 371 Date: Jun. 20, 2023

Related U.S. Application Data
(60) Provisional application No. 63/130,490, filed on Dec. 24, 2020.

(30) Foreign Application Priority Data
Dec. 24, 2020 (NL) 2027217

(51) Int. Cl. B60P 1/38

(52) U.S. Cl. CPC B60P 1/38

(57) ABSTRACT

Disclosed is to a conveyor lamella for a conveyor floor, wherein the conveyor floor is configured for conveying a load in a conveying direction extending between a first end and a second end of the conveyor floor. The conveyor lamella include an elongated lamella body having a first end and a second end, opposite to the first end in the longitudinal direction of the lamella body; and a friction profile provided at the upper surface of the lamella body and extending parallel to the longitudinal direction of the lamella body, wherein the friction profile is configured for increasing the friction coefficient between the conveyor lamella and a load placed thereon.

### BACKGROUND

The invention relates to a conveyor lamella for a conveyor floor, wherein the conveyor floor is configured for conveying a load in a conveying direction extending between a first end and a second end of the conveyor floor. Furthermore, the invention relates to a conveyor floor. The invention also relates to a cargo space and/or a trailer provided with a conveyor floor.

A conveyor floor, for example, is known from the patent specification GB 327772. The known conveyor floor comprises slats or boards mounted on endless chains. The chains run on guide-rails at each side of the vehicle and the boards are carried by bracket-members mounted on the pivot pins of the chains. The guide-rails are formed on longitudinal channel members carried by brackets on the chassis. The boards are secured to the upper run of the endless chains, and the floor is moved towards the rear by an operating hand gear. The boards may be supported at points intermediate of their length by rollers mounted on the chassis. The boards may be hinged together, they may overlap, and they may be constructed of metal sheet.

### SUMMARY OF THE INVENTION

During use of the known conveyor floor, a load placed on top of the conveyor floor and located within a trailer needs to be secured in order to prevent the load from moving within the trailer, for example, due to accelerating or breaking of the trailer. Usually, the load is secured to the walls of the trailer by means of one or more cargo beams, one or more lashing straps or a combination thereof. A disadvantage of using cargo beams and/or lashing straps is that it is usually cumbersome to find a suitable location within the trailer to attach the cargo beams and/or lashing straps in such way that the load is fixed sufficiently and that the cargo beams and/or lashing straps do not damage the load.

It is an object of the present invention to ameliorate or to eliminate one or more disadvantages of the known conveyor floor, to provide an improved conveyor floor or to at least provide an alternative conveyor floor.

According to a first aspect, the invention provides a conveyor lamella for a conveyor floor, wherein the conveyor floor is configured for conveying a load in a conveying direction extending between a first end and a second end of the conveyor floor, the conveyor lamella comprising:
an elongated lamella body having an upper surface, and having a first end and a second end, opposite to the first end in the longitudinal direction of the lamella body; and
a friction profile provided at the upper surface of the lamella body and extending parallel to the longitudinal direction of the lamella body, wherein the friction profile is configured for increasing the friction coefficient between the conveyor lamella and a load placed thereon.

The conveyor lamella according to the invention may be used for forming a conveyor floor within a trailer, wherein the conveyor floor is configured for conveying objects from or into the trailer and in a conveying direction substantially parallel to the longitudinal direction of the trailer. The conveyor floor may comprise a number of parallel series of conveyor lamellas, which may be made from aluminum. Each of the conveyor lamellas is orientated substantially transverse to the conveying direction of the conveyor floor. When during use a load is placed onto the conveyor floor and thus on the conveyor lamellas, the load is at least partially supported by the friction profile of the conveyor lamellas. The friction profiles increase the friction coefficient between the load and the conveyor lamellas, in particular in comparison with a friction coefficient between the elongated lamella body and the load. Due to the increased friction coefficient between the load and the conveyor lamellas, the risk of the load placed at the conveyor lamellas moving with respect to the conveyor lamellas when the trailer is accelerating, braking or making a turn is reduced and in the ideal case eliminated. This is advantageous, as the friction profile eliminates the need of using separate cargo beams and/or lashing straps for securing a load within the trailer.

Additionally, it may be advantageous that the friction profile may prevent the moving floor from slipping with respect to the load thereon when the moving floor starts moving for loading or unloading.

In an embodiment, the friction profile is configured for preventing a load placed on the conveyor lamella from moving at least in a lateral direction with respect to the conveyor lamella. According to this embodiment, the friction profile prevents a load on the conveyor floor from moving because of the trailer in which the conveyor floor is arranged, accelerating or braking.

In an embodiment, the elongated lamella body has an upper wall in which a groove is provided, wherein the groove is provided for receiving the friction profile at least partially. In an embodiment thereof, the groove is extending over substantially the entire length of the elongated lamella body and/or is provided in the center thereof. Preferably, the upper side of the friction profile is located above the upper surface of the elongated lamella body. The inventors have found that because of condensation between conveyor lamellas and a load placed thereon, the conveyor lamellas may leave prints on the load. Since the upper side of the friction profile is located above the upper surface of the elongated lamella body, the load is substantially supported by the friction profiles of the conveyor floor. As a result, condensation no longer occurs. This is advantageous, since the risk of conveyor lamellas leaving prints on a load is reduced or in the ideal case eliminated.

In an embodiment, the upper side of the friction profile is provided with a number of ridges extending substantially parallel to each other. The number of ridges are provided for enlarging the engaging surface of the friction profile which engages the load placed on the conveyor floor, and for further increasing advantageously the friction coefficient between the friction profile and the load, in particular in comparison with a friction coefficient between the elongated lamella body and the load.

In an embodiment, the friction profile comprises a cord-like profile body, wherein the cord-like profile body is placed and/or glued within the groove.

In an embodiment, the groove has a first groove portion and a second groove portion, wherein the first and second groove portions are arranged in series in a direction from the upper side to the bottom side of the elongated lamella body. In a further embodiment, the friction profile has a profile body having a first body portion and a second body portion. In an embodiment thereof, the first groove portion is configured for receiving the first body portion, and the second groove portion is configured for receiving the second body portion and for anchoring the second body portion therein. By anchoring the second body portion of the friction profile within the second groove portion, the friction profile is prevented advantageously from being forced out of the groove when a lateral force is applied to the friction profile. Such a lateral force may be the result of the trailer accelerating or braking. Furthermore, the lateral force may be transferred to the conveyor lamella and, subsequently, to a conveyor chain to which the conveyor lamella may be connected, such that the conveyor chains absorbs or counteracts the lateral force.

In an embodiment, the groove has an inverted T-shape.

In an embodiment, the first groove portion is converging in a direction from the upper side to the bottom side of the elongated lamella body, and the second groove portion has a semi-dome shape having a curved wall portion and straight wall portion with a through hole therein. In a further embodiment, the first groove portion is bounded by a first abutting surface and a second abutting surface, opposite to the first abutting surface. In an even further embodiment, the first body portion is converging in a direction from the upper side to the bottom side of the elongated lamella body and comprises side walls configured for abutting against the first or second abutting surface, respectively, of the first groove portion. When a lateral force is applied to the friction profile by a load, the first body portion is moved towards one of the first and second abutting surfaces in order to abut against the respective abutting surface. Optionally, the first body portion is tilted with respect to the second body portion. Due to the first body portion abutting against the abutting surface, the lateral force will be transferred from the first body portion to the elongated lamella body, while the first body portion is prevented from moving further in the direction of the lateral force.

In an embodiment, the second body portion has a frusto-triangular shape when seen in cross-section, wherein the second body portion has a base facing the first body portion and at which the second body portion is connected to the first body portion via a transition portion. In an embodiment thereof, the base has a base width and the straight wall portion has a wall width, wherein the base width and the wall width correspond to each other. According to this embodiment, the base of the second body portion is located directly adjacent to the straight wall portion of the second groove portion. This is advantageous, since a lateral force acting on the first body portion of the friction groove may also be counteracted by the straight wall portion of the second groove portion.

In an embodiment, a coupler is arranged removably at the first end and the second end of the elongated lamella body, wherein the coupler is configured for coupling the conveyor lamella to a drive, such as a conveyor chain. As a result, the friction profile may be slid into the groove within the elongated lamella body from one of the ends thereof. The friction profile is locked up within the groove by the couplers. This is advantageous, as the friction profile may be installed without additional securing means, such as glue, screws or clinchers.

In an embodiment, the elongated lamella body is manufactured from a material selected from the group comprising aluminum, synthetic material and steel, and the friction profile is manufactured from an elastic and rubber-like material, such as soft PVC, NBR or TPU. The inventors have surprisingly found that an elastic and rubber-like material results in a friction coefficient high enough for preventing a load on the conveyor lamella from moving with respect to the lamella.

In an embodiment, the conveyor lamella comprises one or more friction profiles at the upper surface of the lamella body and extending parallel to the longitudinal direction of the lamella body.

In an embodiment the friction profile comprises an upper surface that directly merges into the upper surface of the elongated lamella body, whereby a load is supported by the upper surface 38 of the friction profile as well as by the adjacent upper surface of the lamella body.

According to a second aspect, the invention provides a conveyor floor, wherein the conveyor floor is configured for conveying a load in a conveying direction extending between a first end and a second end of the conveyor floor, the conveyor floor comprising:
a plurality of conveyor lamellas according to the first aspect of the invention arranged next to each other and orientated substantially transverse to the conveying direction, wherein each of the plurality of conveyor lamellas at at least one of the ends thereof is connected to a drive, such as a conveyor chain; and
a drive configured for moving the plurality of conveyor lamellas in the conveying direction.

The conveyor floor has at least the same technical advantages as described in relation to the first aspect of the invention.

In an embodiment of the conveyor floor are in a series of multiple directly next to each other arranged conveyor lamellas, all conveyor lamellas each provided with a friction profile. The series may extend over the entire conveyor length in the conveying direction.

According to a third aspect, the invention provides a cargo space and/or trailer with a conveyor floor according to the second aspect of the invention.

The cargo space and/or trailer has at least the same technical advantages as described in relation to the first aspect of the invention.

According to a fourth aspect, the invention provides a loading/unloading assembly for loading/unloading a trailer, the loading/unloading assembly comprising:
an loading/unloading track having a conveyor floor according to the second aspect of the invention.

The loading/unloading assembly has at least the same technical advantages as described in relation to the first aspect of the invention.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIG. 1 shows schematically a trailer having a conveyor floor according to an embodiment of the invention;

FIG. 2 shows schematically a loading/unloading arrangement with the trailer of FIG. 1;

FIG. 3 shows a top view of a portion of the conveyor floor of FIG. 1, having a plurality of conveyor lamellas;

FIGS. 4A-4B show an isometric view and a cross-section view, respectively, of a conveyor lamella with a friction profile of FIG. 3; and

FIG. 4C shows an isometric view of a part of the friction profile of FIGS. 4A and 4B.

### DETAILED DESCRIPTION OF THE INVENTION

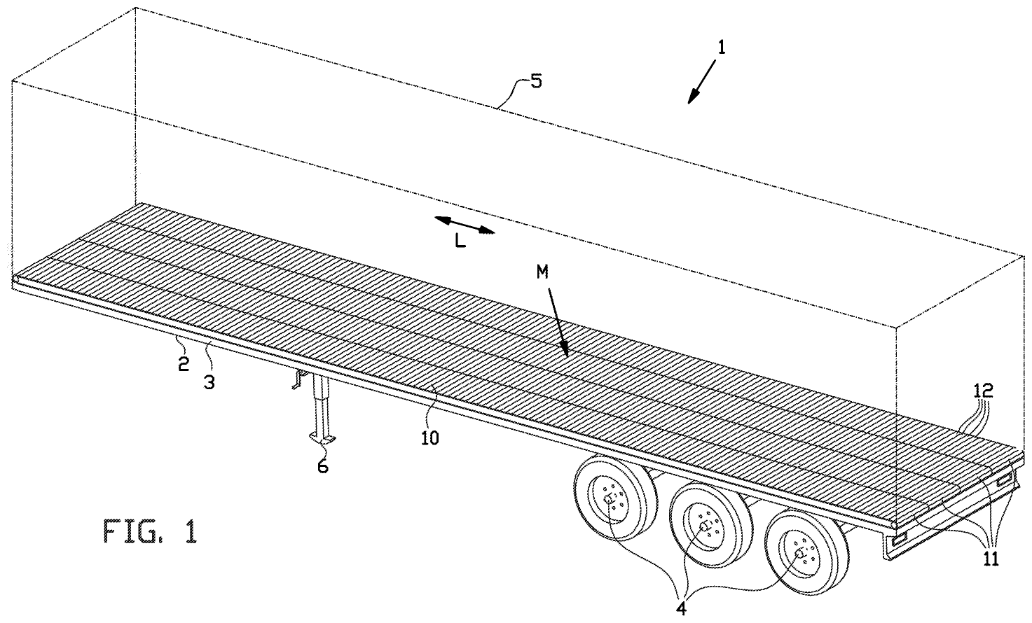

FIG. 1 shows a trailer 1 with a conveyor floor 10 according to an embodiment of the invention. The trailer 1 comprises a trailer frame 2 forming a trailer floor 3 and a schematically indicated hood 5 that covers the area above the conveyor floor 10. The trailer floor 3 and the schematically indicated hood 5 together define a cargo space. The trailer 1 furthermore comprises multiple wheel axes 4, and at least one retractable stand 6 to support the uncoupled trailer 1. The conveyor floor 10 according to the invention is not limited to trailer applications, but can also be applied in trucks or in fixed structures. The conveyor floor 10 has a horizontally extending main plane M that extends over the entire cargo area of the trailer 1 or the conveyor floor 10. The conveyor floor 10, also known as a so-called lamella floor, is configured to move the cargo forwards and backwards in the main plane M in its longitudinal direction L as described hereafter.

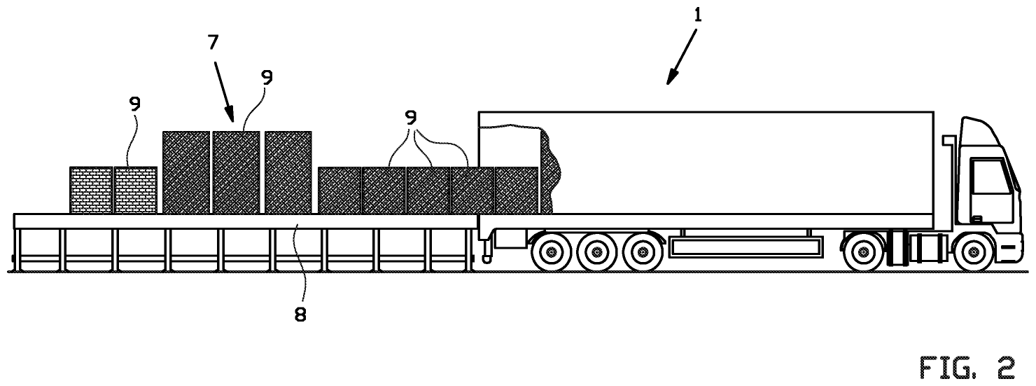

An embodiment of a loading/unloading arrangement 7 configured for loading or unloading the trailer 1 of FIG. 1 is shown in FIG. 2. The loading/unloading arrangement 7 has a loading/unloading track 8, which for example are used in so-called distribution centres, on which objects 9 to be loaded/unloaded are placed. The loading/unloading track 8 is provided with a conveyor floor which corresponds to the conveyor floor 10 as provided within the trailer 1. As shown, the trailer 1 is placed against an end of the loading/unloading track 8 in order to be able to load/unload the objects 9 into or from the trailer 1, in particular the cargo space thereof.

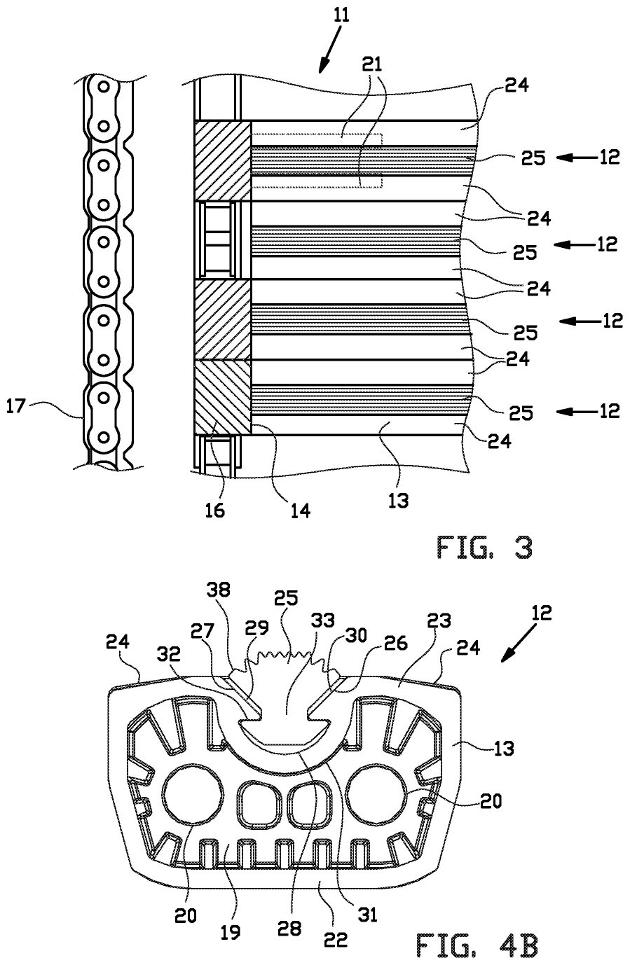

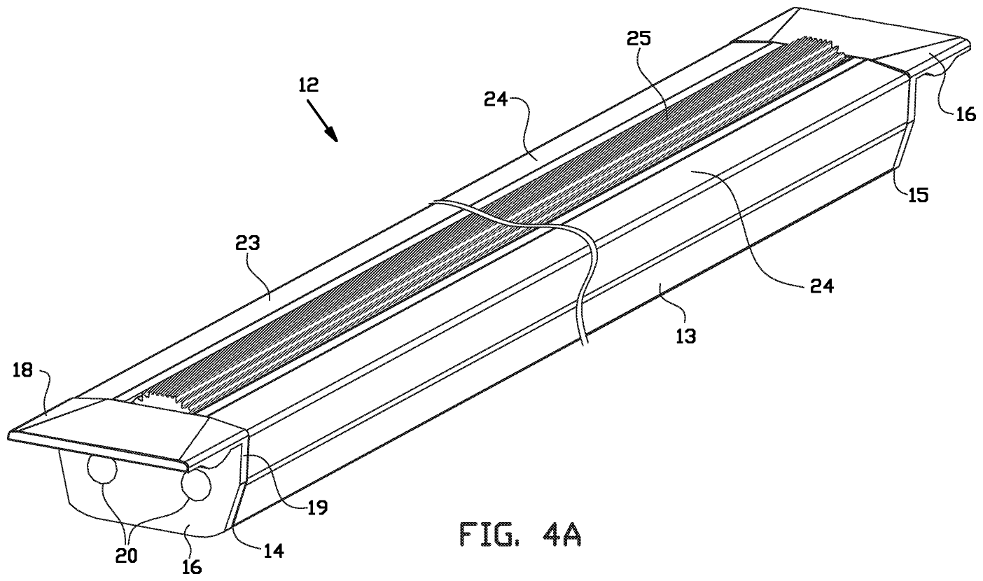

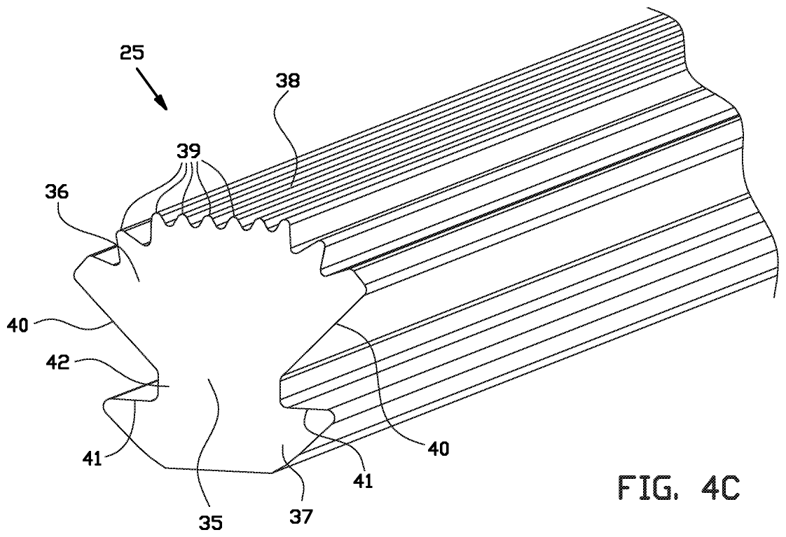

The conveyor floor 10 comprises four parallel series 11 of lamellas 12, which may be made from aluminum. As shown in FIG. 3, showing a top view of a portion of one of the series 11 of lamellas 12, each of the lamellas 12 has an elongated lamella body 13, which is hollow whereby the lamella body 13 has a bottom wall 22, and an upper wall 23 with an abutment upper surface 24. The lamella body 13 has a first end 14 and a second end 15, opposite to the first end in the longitudinal direction of the lamella 12. At each of the ends 14, 15, a coupler 16 is provided for coupling the lamella 12 to a conveying chain 17. As follows from FIG. 4, each coupler 16, which may be made from synthetic material, is arranged in the hollow lamella body 13 by means of a non-shown insertion part. The coupler 16 continues in the direction of extension of the lamella 12 in a collar 18 which is connected to the non-shown insertion part by means of a bridge part 19. The collar 18 extends over the conveying chain 17 in order to prevent a load or person on the conveying floor 10 from contacting the conveying chain 17. The collar 18, the bridge part 19 and the insertion part are formed as a unity. The bridge part 19 has two receiving openings 20 facing towards the conveying chain 17. The receiving openings 20 are configured for receiving coupler pins 21 configured for coupling the conveying chain 17 and the lamella 12 to each other.

As shown in FIGS. 4A and 4B, in which a single lamella 12 is shown, the lamella 12 is provided with a friction profile 25 at the upper wall 23 of the elongated lamella body 13. The friction profile 25 is configured for increasing the friction coefficient between a load placed on the conveyor floor 10 in comparison with the friction coefficient between the aluminum of the lamella body 13 and the load. In this embodiment, the friction profile 25 extends from the first end 14 to the second end 15 of the lamella body 13.

In order to be able to arrange the friction-increasing profile 25 at the lamella body 13, the upper wall 23 of the lamella body 13 is provided with a groove 26 extending along the longitudinal direction thereof and arranged within the middle thereof. As shown in FIG. 4B, the groove 26 may have an inverted T-shape when seen in cross-section. The groove 26 has a first groove portion 27 and a second groove portion 28 arranged in series in a direction from the upper wall 23 to the bottom wall 22 of the lamella body 13. The first groove portion 27 is converging in the direction from the upper wall 23 to the bottom wall 22, such that the first groove portion 27 narrows towards the bottom wall 22. The first groove portion 27 is bounded by a first abutting surface 29 and a second abutting surface 30. The second groove portion 28 has a semi-dome shape, having a curved wall portion 31 and a straight wall portion 32. A passage or through hole 33 is provided within the straight wall portion 32 in order to allow at least a part of the friction profile 25 to be inserted into the second groove portion 28. The groove 26 is accessible from the first and second ends 14, 15 of the lamella body 13.

The friction profile 25, as shown in FIG. 4C, has a profile body 35 that may be made of an elastic and rubber-like material, such as soft PVC, NBR or TPU. The profile body 35 has a first body portion 36 and a second body portion 37, wherein the first body portion 36 is configured to be received within the first groove portion 27 and the second body portion 37 is configured to be received within the second body portion 28. The first body portion 36 is converging in the direction from the upper wall 23 to the bottom wall 22 of the lamella body 13 when seen in cross-section. At the upper side, the first body portion 36 is provided with a number a ridges 39 extending substantially parallel to each other. The ridges 39 are configured for further increasing the friction between the friction profile 25 and the load placed on the conveyor floor 10, and for enlarging the abutment upper surface 38 of the friction profile 25. As shown in FIG. 4C, the ridges 39 may have different widths and heights with respect to each other, such that the outer ridges 39 are wider and higher than the inner ridges 39. As shown in FIG. 4B, the first body portion 36 and thus the ridges 39 extend out of the groove 26 and beyond the upper wall 11 of the lamella body 13. As shown in FIG. 4B, on both sides of the friction profile 25 the upper surface 38 of the friction profile 25 directly continues into the adjacent upper surface 24 of the lamella body 13.

The first body portion 36 further has side walls being substantially parallel to the first abutting surface 29 and the second abutting surface 30, and configured for abutting against one of the first and second abutting surfaces 29, 30 when a force is applied to the friction profile 25 in a direction substantially transverse to the longitudinal direction thereof, for example during accelerating or braking of the trailer 1.

As shown in FIG. 4C, the second body portion 37 may have a frusto-triangular shape when seen in cross-section, forming an anchoring part. The second body portion 37 has a base 41 facing the first body portion 36 and at which the second body portion 37 is connected to the first body portion 36 via a transition portion 42. The base 41 has a base width which corresponds to the wall width of the straight wall portion 32 of the second groove portion 28, such that the base 41 is placed directly below the straight wall portion 32. The transition portion 42 is located within the through hole 33. The second body portion 37 is locked up within the second groove portion 28, such that the friction profile 28 is prevented from being pushed out of the groove 26 when a lateral force is applied to the friction profile 25.

In order to install the friction profile 25 within the groove 26, one of the couplers 16 needs to be removed from the lamella body 13. Subsequently, the friction profile 25 may be slid into the groove 26, whereafter the coupler 16 may be placed back at the lamella body 13. Then, the lamella 12 is ready to be used in a conveyor floor 10. When the objects 9 to be loaded/unloaded are placed onto the lamella 12, they are supported by the upper surface 38 of the downward elastically compressed friction profile 25 as well as by the adjacent upper surface 24 of the lamella body 13.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-24. (canceled)

25. A conveyor lamella for a conveyor floor, wherein the conveyor floor is configured for conveying a load in a conveying direction extending between a first end and a second end of the conveyor floor, the conveyor lamella comprising:
an elongated lamella body having an upper surface, and having a first end and a second end, opposite to the first end in the longitudinal direction of the lamella body; and
a friction profile provided at the upper surface of the lamella body and extending parallel to the longitudinal direction of the lamella body, wherein the friction profile is configured for increasing the friction coefficient between the conveyor lamella and a load placed thereon.

26. The conveyor lamella according to claim 25, wherein the elongated lamella body has an upper wall in which a groove is provided, wherein the groove is provided for receiving the friction profile at least partially.

27. The conveyor lamella according to claim 26, wherein the groove is extending over substantially the entire length of the elongated lamella body and/or is provided in the center thereof.

28. The conveyor lamella according to claim 26, wherein the upper side of the friction profile is located above the upper surface of the elongated lamella body.

29. The conveyor lamella according to claim 26, wherein the upper side of the friction profile is provided with a number of ridges extending substantially parallel to each other.

30. The conveyor lamella according to claim 26, wherein the friction profile comprises cord-like profile body, wherein the cord-like profile body is placed and/or glued within the groove.

31. The conveyor lamella according to claim 26, wherein the groove has a first groove portion and a second groove portion, wherein the first and second groove portions are arranged in series in a direction from the upper side to the bottom side of the elongated lamella body.

32. The conveyor lamella according to claim 31, wherein the friction profile has a profile body having a first body portion and a second body portion.

33. The conveyor lamella according to claim 32, wherein the first groove portion is configured for receiving the first body portion, and the second groove portion is configured for receiving the second body portion and for anchoring the second body portion therein.

34. The conveyor lamella according to claim 33, wherein the groove has an inverted T-shape, wherein the first groove portion is converging in a direction from the upper side to the bottom side of the elongated lamella body, and the second groove portion has a semi-dome shape having a curved wall portion and straight wall portion with a through hole therein.

35. The conveyor lamella according to claim 34, wherein the first groove portion is bounded by a first abutting surface and a second abutting surface, opposite to the first abutting surface.

36. The conveyor lamella according to claim 35, wherein the first body portion is converging in a direction from the upper side to the bottom side of the elongated lamella body and comprises side walls configured for abutting against the first or second abutting surface, respectively, of the first groove portion.

37. The conveyor lamella according to claim 34, wherein the second body portion has a frusto-triangular shape when seen in cross-section, wherein the second body portion has a base facing the first body portion and at which the second body portion is connected to the first body portion via a transition portion.

38. The conveyor lamella according to claim 37, wherein the base has a base width and the straight wall portion has a wall width, wherein the base width and the wall width correspond to each other.

39. The conveyor lamella according to claim 25, wherein the elongated lamella body is manufactured from a material selected from the group comprising aluminum, synthetic material and steel, and the friction profile is manufactured from an elastic and rubber-like material.

40. The conveyor lamella according to claim 25, wherein the friction profile comprises an upper surface that directly merges into the upper surface of the elongated lamella body.

41. The conveyor floor configured for conveying a load in a conveying direction extending between a first end and a second end of the conveyor floor, the conveyor floor comprising:
a plurality of conveyor lamellas according to claim 25 arranged next to each other and orientated substantially transverse to the conveying direction, wherein each of the plurality of conveyor lamellas at least one of the ends thereof is connected to a drive, such as a conveyor chain; and
a drive configured for moving the plurality of conveyor lamellas in the conveying direction.

42. The conveyor floor according to claim 41, wherein in a series of multiple next to each other arranged conveyor lamellas, all conveyor lamellas are each provided with a friction profile.

43. A loading/unloading assembly for loading/unloading a trailer, the loading/unloading assembly comprising:
an loading/unloading track having a conveyor floor according to claim 41.
